(19) United States
(12) Patent Application Publication
(10) Pub. No.: US 2017/0018147 A1
(43) Pub. Date: Jan. 19, 2017

(54) GAMING SYSTEM AND A METHOD OF GAMING

(71) Applicant: Aristocrat Technologies Australia Pty Limited, North Ryde (AU)

(72) Inventors: Tricia Tylman, Las Vegas, NV (US); Gary Joseph Penacho, Henderson, NV (US); Scott Monroe Stewart, Las Vegas, NV (US)

(21) Appl. No.: 15/278,635

(22) Filed: Sep. 28, 2016

Related U.S. Application Data
(63) Continuation of application No. 14/092,292, filed on Nov. 27, 2013, now abandoned.
(60) Provisional application No. 61/731,589, filed on Nov. 30, 2012.

(51) Int. Cl. G07F 17/34; G07F 17/32

(52) U.S. Cl. CPC G07F 17/34; G07F 17/3213; G07F 17/3265; G07F 17/3209; G07F 17/3246

(57) ABSTRACT

A gaming system in which at least one symbol is selected for display in at least one but not all of a plurality of display position groups. The player indicates whether to keep the symbols displayed in the first set of display position groups before symbols are selected for a second set of display position groups. If not kept, symbols are re-selected for the first set of display position groups. Symbols are then selected for display in the second set of display position groups.

### RELATED APPLICATIONS

This application is a continuation of U.S. application Ser. No. 14/092,292, having a filing date of Nov. 27, 2013, which claims priority to, and is a Non-Provisional of, U.S. Provisional Application No. 61/731,589, having a filing date of Nov. 30, 2012, each of the above-identified applications is incorporated herein by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention relates to a gaming system and to a method of gaming. It is known to provide a gaming system arranged to randomly display several symbols from a predetermined set of symbols and to determine a game outcome such as a game win based on the displayed symbols.

Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system comprising:

a selector arranged to select at least one symbol from a set of symbols for display in a first set of display position groups, the first set of display position groups comprising at least one display position group but not all display position groups of a plurality of display position groups;

the gaming system being arranged to receive an instruction from a player indicative of whether the player wishes to keep the symbols selected for display in the first set of display position groups before symbols are selected for display in a second set of display position groups different to the first set of display position groups;

the selector being arranged to re-select symbols for display in the first set of display position groups if the instruction from the player is indicative that the player does not wish to keep the symbols selected for display in the first set of display position groups;

the gaming system being arranged to keep the symbols selected for display in the first set of display position groups if the instruction from the player is indicative that the player wishes to keep the symbols selected for display in the first set of display position groups; and
the selector being arranged to select symbols for display in the second set of display position groups after receiving the instruction from the player;

the gaming system further comprising:

an outcome evaluator arranged to determine whether the displayed symbols define

a winning symbol combination; and

a prize allocator arranged to allocate a prize when a winning symbol combination is displayed.

In one embodiment, the gaming system comprises at least one shutter arranged to conceal the second set of display position groups until the instruction is received from a player indicative of whether the player wishes to keep the symbols selected for display in the first set of display position groups. The at least one shutter may be virtual or physical.

In one embodiment, each display position group of the second set of display position groups has a separate associated shutter.

In one embodiment, each display position group comprises display positions of a reel. The reels may be virtual or physical reels.

In one embodiment, 5 reels are provided, and the first set of display position groups comprise display positions of 3 reels.

In one embodiment, the first set of display position groups may comprise 3 adjacently disposed display position groups. The 3 adjacently disposed display position groups may be leftmost disposed display position groups.

In one embodiment, the first set of display position groups comprises at least one display position group randomly selected from the plurality of display position groups.

The gaming system may be operable in base game mode or special game mode, wherein:

in base game mode, the gaming system implements a base game wherein the gaming system is not arranged to receive an instruction from a player indicative of whether the player wishes to keep the symbols selected for display in the first set of one or more display position groups; and

in special game mode, the gaming system implements a feature game wherein the gaming system is arranged to receive an instruction from a player indicative of whether the player wishes to keep the symbols selected for display in the first set of one or more display position groups.

In one embodiment, the gaming system is arranged to commence special game mode when a trigger condition occurs.

In one embodiment, the gaming system is arranged to commence special game mode in response to player input, based on the amount or type of bet placed, or when a special game is purchased by a player.

The trigger condition may be display of a particular symbol, or display of a defined symbol combination.

In accordance with a second aspect of the present invention, there is provided a method of gaming comprising:

selecting a plurality of symbols from a set of symbols for display in a first set of display position groups of a plurality of display position groups, the first set of display position groups comprising at least one display position group but not all of the display position groups;

receiving an instruction from a player indicative of whether the player wishes to keep the symbols selected for display in the first set of display position groups before symbols are selected for display in a second set of at least one display position group different to the first set of display position groups;

re-selecting symbols for display in the first set of display position groups if the instruction from the player is indicative that the player does not wish to keep the symbols selected for display in the first set of display position groups;

keeping the symbols selected for display in the first set of display position groups if the instruction from the player is indicative that the player wishes to keep the symbols selected for display in the first set of display position groups;

selecting symbols for display in the second set of display position groups after receiving the instruction from the player;

determining whether the displayed symbols define a winning symbol combination; and

allocating a prize when a winning symbol combination is displayed.

In accordance with a third aspect of the present invention there is provided a computer program arranged when loaded into a computer to instruct the computer to operate in accordance with the gaming system of the first aspect.

In accordance with a fourth aspect of the present invention, there is provided a computer readable medium having a computer readable program code embodied therein for causing a computer to operate in accordance with the gaming system of the first aspect.

In accordance with a fifth aspect of the present invention, there is provided a data signal having a computer readable program code embodied therein to cause a computer to operate in accordance with the gaming system of the first aspect.

### BRIEF DESCRIPTION OF SEVERAL VIEWS OF THE DRAWINGS

In order that the present invention may be more clearly ascertained, embodiments of the present invention will now be described, by way of example only, with reference to the accompanying drawings, in which:

FIG. 1 is a schematic block diagram of components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention wherein the gaming system is implemented over a network;

FIG. 7 is a flow diagram illustrating game play of a gaming system in accordance with an embodiment of the present invention; and

FIGS. 8 to 13 are diagrammatic representations of a display area of a gaming system shown during implementation of a game.

### DETAILED DESCRIPTION OF THE INVENTION

The present gaming system operates such that during game play, a plurality of symbols are randomly selected from a set of symbols and displayed in a corresponding plurality of display position groups, each of which comprises a plurality of display positions. The symbols shown at the display positions are used to determine game outcomes by comparing the displayed symbols with defined winning combinations.

In one conventional type of gaming machine, a display area including 15 display positions is presented to a player with each display position including one symbol. The display positions are arranged in five vertically disposed display position groups, with each display position group corresponding to a rotatable reel, and each reel having three visible display positions. After the reels are spun and subsequently stopped, the display positions show a random selection of symbols.

Generally, with such games, a plurality of win patterns in the form of win lines are defined which extend across the reels and include one display position from each reel. Typically the symbols that are disposed in a win line are compared with winning symbol combinations defined in a pay table so as to determine whether a player of the game should receive an award. For example, if winning symbol combinations are based on poker hands, a particular prize would be awarded if the win line comprises four aces. Other winning symbol combinations and corresponding prizes may also be defined.

Such a game often comprises normal game mode and special game mode. During normal game mode, the displayed symbols are compared with winning combinations defined in a pay table.

With the present system, during special game mode, the gaming system is arranged to select symbols in a first set of display position groups, and provide the player with the option of keeping the selected symbols or re-selecting symbols for display in the first set of display position groups before symbols are selected for display in a remaining second set of display position groups. In this way, interactivity between the gaming system and a player is increased, and the player has a degree of control over the game in a way similar to draw poker whereby the player has the option of keeping or replacing the symbols initially displayed. While the present embodiment is described in relation to implementation of this functionality during special game mode, it will be understood that the functionality may be implemented during normal game mode of a multi-mode gaming system, or in a gaming system that has only a single mode of operation.

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. The system is of the type including multiple game modes, such as being operable in normal game mode wherein a base game is implemented and special game mode wherein a feature game is implemented.

With some such probabilistic games, the set of symbols used during normal game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

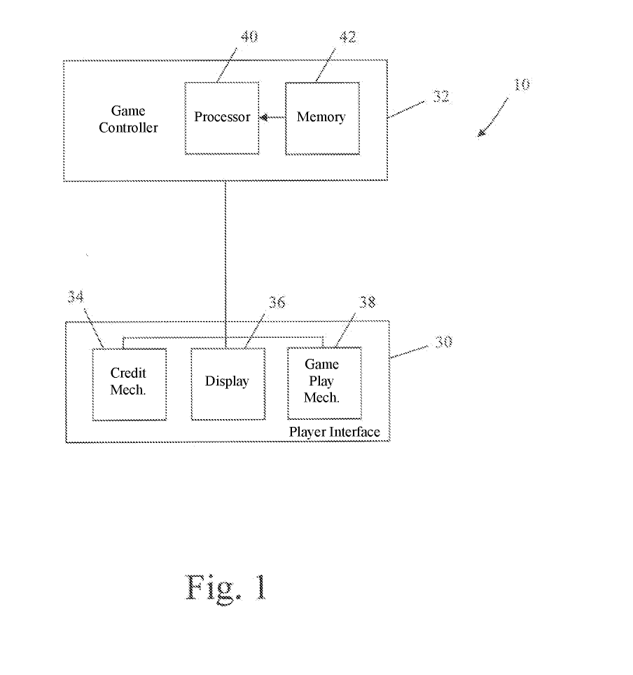

Referring to FIG. 1, a schematic diagram of components of a gaming system 10 in accordance with the present embodiment is shown. The components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, and a game play mechanism 38 arranged to enable a player to input game play instructions.

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

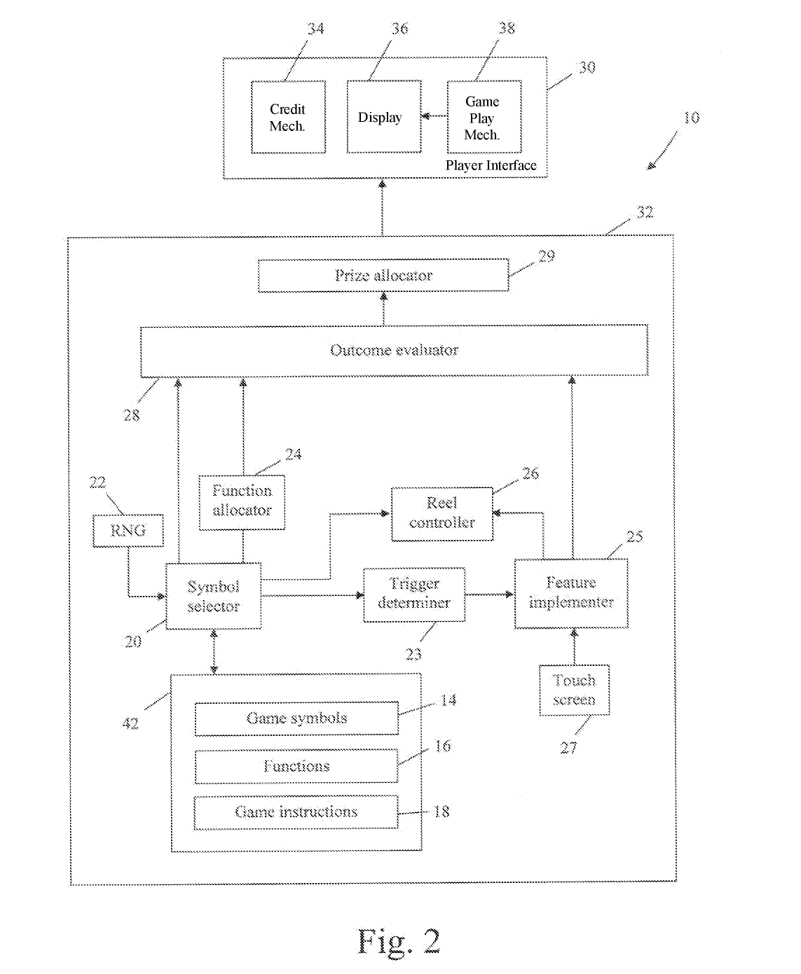

A functional diagram illustrating operative components of the game controller 32 is shown in FIG. 2.

The memory 42 is arranged to store symbols data 14 indicative of a plurality of symbols, in the present example associated with a plurality of reels, win lines data 16 indicative of available win lines, and game instruction data 18 indicative of game instructions usable by the gaming machine 10 to control operation of the game.

The game controller 32 includes a symbol selector 20 which is arranged to select several symbols from the available symbols 14 for display to a player in a plurality of display positions, in this example by spinning reels containing the symbols and stopping the reels so as to display at least one symbol on each reel. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

The symbol selector 20 interfaces with a reel controller 26 arranged to control and coordinate the reels, and in particular to control the stopping positions of the reels.

With this embodiment, the game controller 32 also comprises a trigger determiner 23 arranged to determine whether a trigger condition exists, and a feature implementer 25 arranged to implement a feature game when a trigger condition is determined to exist.

During a feature game, the feature implementer 25 causes the symbol selector 20 to select symbols for display from a first set of symbol display groups, in this example symbols from some but not all of the reels, and causes the reel controller 26 to spin all of the reels and subsequently stop some but not all of the reels in order to thereby display the symbols selected in the first set of symbol display groups. No symbols are displayed at this stage in a second set of symbol groups, in this example the remaining reels, and these reels continue to spin. The player is then provided with the option of keeping the symbols selected for display in the first set of symbol display groups or re-selecting the symbols for display in the first set of symbol display groups and thereby re-spinning the reels associated with the first set of symbol display groups. Player selection may be made using a touch screen 27, using buttons, or in any other way

The game controller 32 also comprises an outcome evaluator 28 which, in accordance with game instructions 18, determines game outcomes based on the symbols selected for display to the player by the symbol selector 20 after all reels have stopped spinning.

The game controller 32 also comprises a prize allocator 29 arranged to allocate a prize to a player when a winning outcome exists.

In the present embodiment, the symbol selector 20, the trigger determiner 23, the function allocator 24, the feature implementer 25, the reel controller 26, the outcome evaluator 28, and the prize allocator 29 are at least partly implemented using the processor 40 and associated software although it will be understood that other implementations are envisaged.

The gaming system 10 can take a number of different forms.

In a first form, a player operable gaming device in the form of a stand alone gaming machine is provided wherein all or most components required for implementing the game are present in the gaming machine.

In a second form, a distributed architecture is provided wherein some of the components required for implementing the game are present in a player operable gaming device and some of the components required for implementing the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a device server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

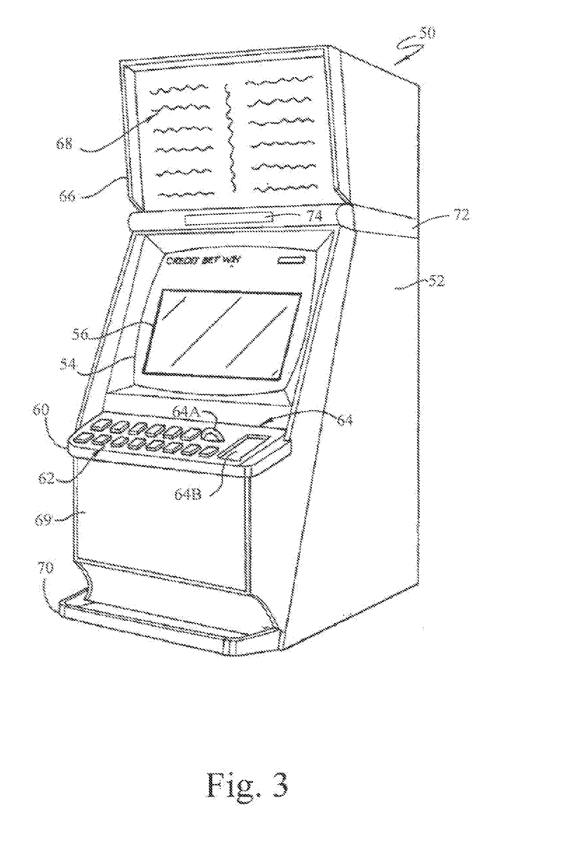

A gaming system in the form of a stand alone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during gameplay. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may comprise a touch screen usable by a player to interact with the gaming machine, in particular during game play.

The display 54 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

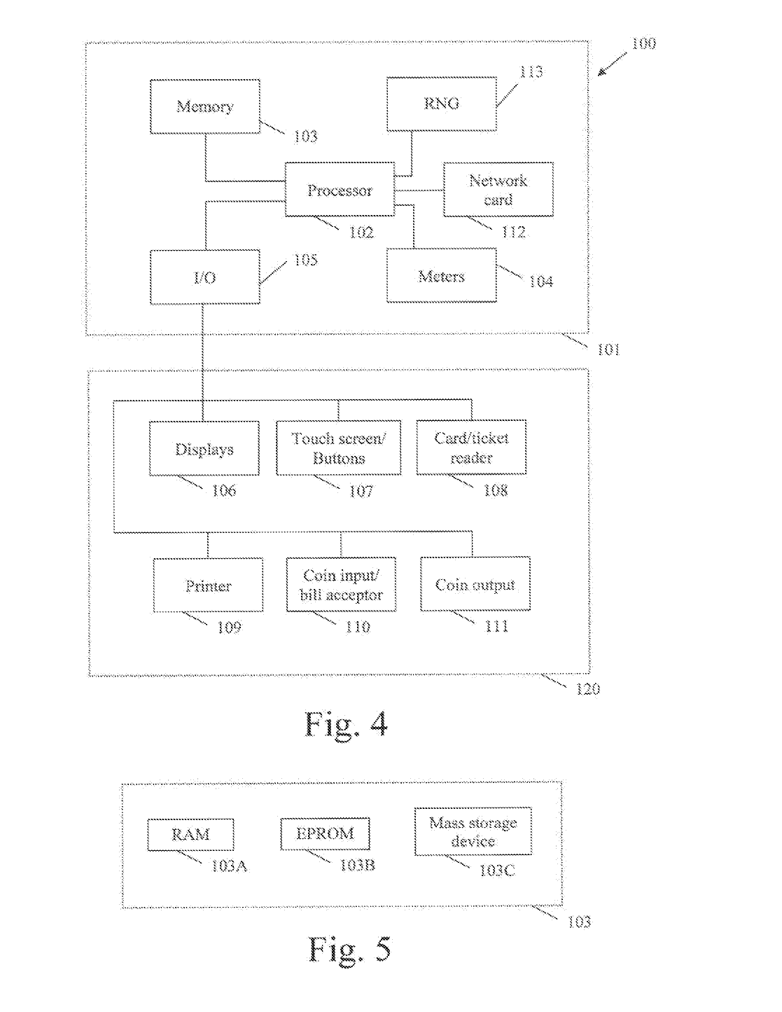

FIG. 4 shows a block diagram of operative components of a gaming device 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106; a touch screen and/or bank of buttons 107 including at least one input device, such as at least one button, to enable a player to provide an indication as to whether the player wishes to keep symbols displayed in some of the reels or re-spin the reels; a card and/or ticket reader 108; a printer 109; a bill acceptor and/or coin input mechanism 110; and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

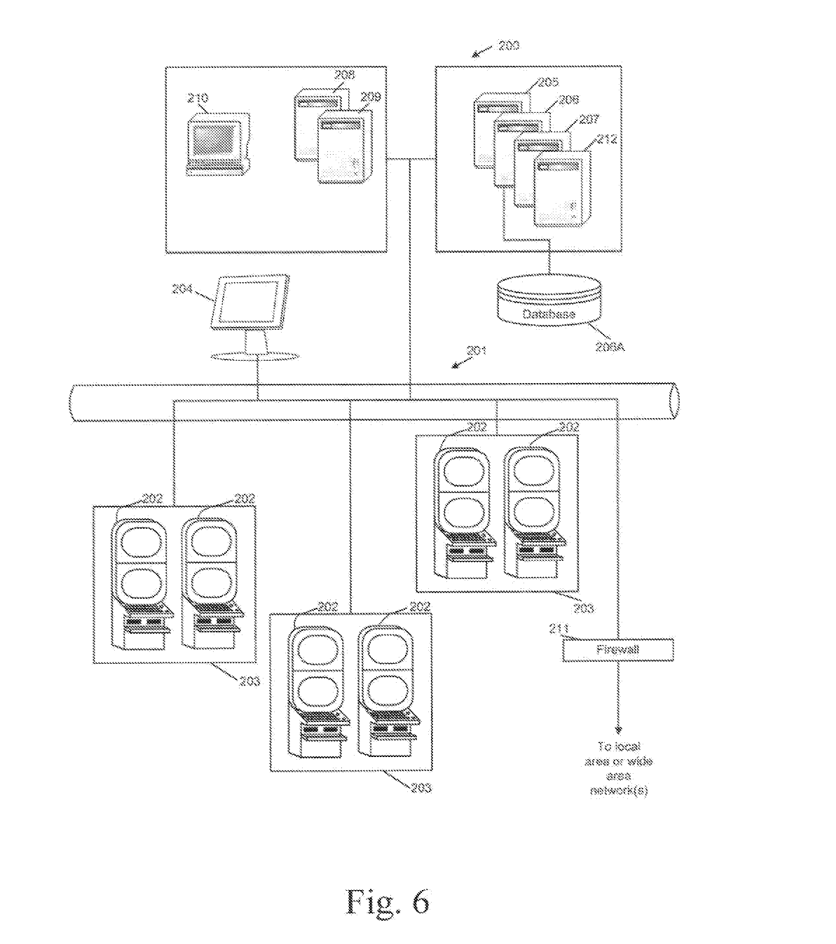

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine.

Alternatively, a separate random number generator server could be provided.

Examples of specific implementations of the gaming system will now be described in relation to a stand alone gaming machine 50 although it will be understood that implementation may also be carried out using other gaming system architectures such as a network architecture of the type shown in FIG. 6.

In this example, the gaming system comprises five reels, each reel corresponding to a display position group having an associated set of display positions for displaying symbols. The reels may be mechanical or virtual.

The reels are arranged to display standard symbols and one or more function symbols and win outcomes are determined on the basis of the symbols visible at the display positions when the reels stop.

Typically, a player will purchase or otherwise obtain win entitlements such as several win lines which are used in the game to determine win outcomes. If the displayed symbols on the reels have symbols associated with a winning combination such as a winning combination disposed on a win line, the player wins a prize.

The gaming system is operable in normal game mode and special game mode and may be arranged to commence special game mode when a predetermined game outcome occurs. Special game mode may comprise one or more free games. Special game mode may commence automatically on the basis of a game event occurring during a game such as display of a particular symbol, based on game outcomes determined by the gaming system, or may be prompted by a player pressing a button on the gaming system 10 after the player has identified that a game outcome corresponding to special game mode requirements has occurred.

The gaming system 10 may also be arranged so as to determine eligibility for special game mode, for example based on the amount or type of bet placed, based on particular time periods and so on.

Special game mode may also be arranged to commence when a special game is purchased by a player.

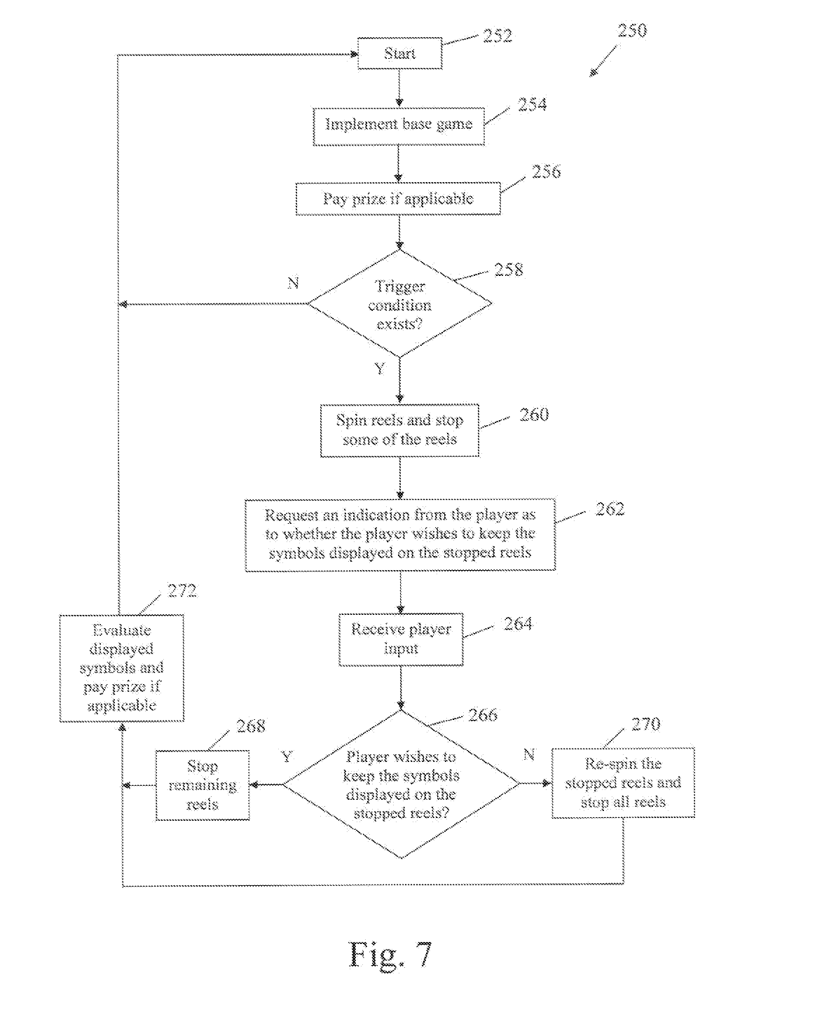

A specific example will now be described in relation to flow diagram 250 shown in FIG. 7 which illustrates steps 252 to 272 of a method of gaming implemented by the gaming system according to the present embodiment.

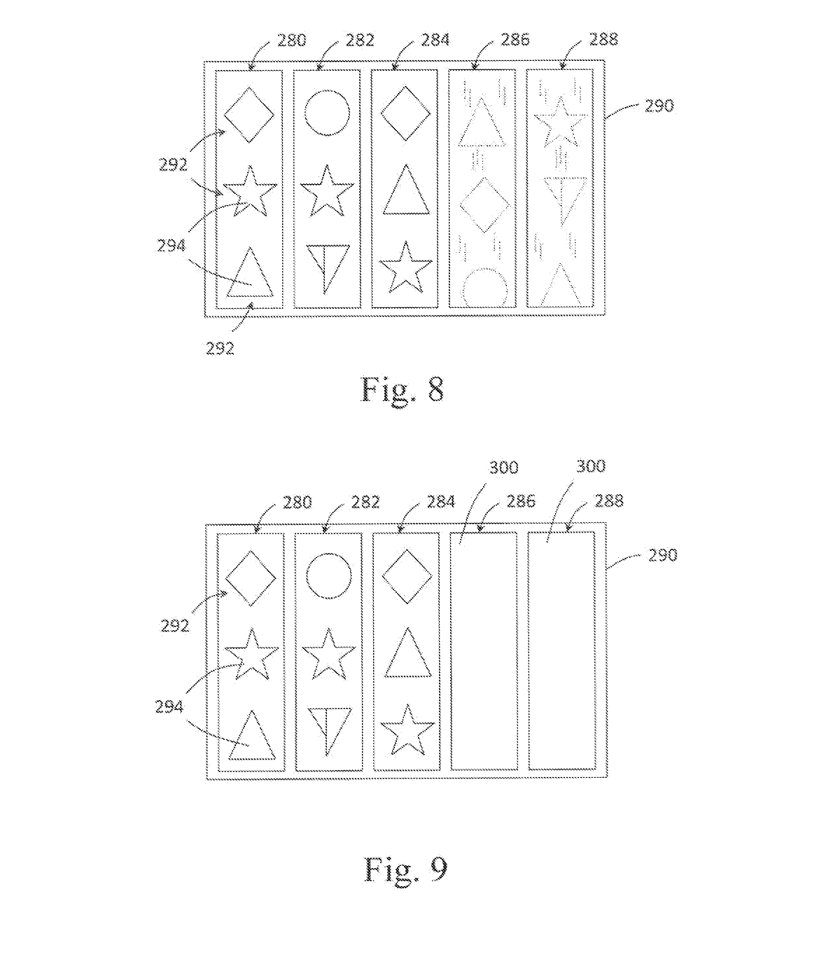

As shown in FIGS. 8 to 13, in this example, five virtual reels 280, 282, 284, 286, 288 are provided and displayed on a graphical display device 54 in a display area 290. Each reel 280, 282, 284, 286, 288 corresponds to a display position group, and each reel comprises three display positions 292 for displaying symbols 294. However, it will be understood that any number of reels may be provided.

During implementation 254 of a base game, the reels are spun and subsequently stopped to show a plurality of symbols 294 in the display area 290. Winning outcomes are determined with reference to symbols 294 appearing in the display area 290, for example along defined win lines.

The outcome generator 28 determines whether the symbols displayed at the display positions correspond to a winning outcome and, if a winning outcome exists, a prize associated with the winning outcome is awarded 256 to the player. This determination is made by comparing the symbols displayed at the display positions with a pay table or similar.

If a predefined game outcome occurs 258 during the base game, such as display of a defined combination of symbols, the gaming system implements a feature game.

During implementation of the feature game, the reels are caused to spin and some of the reels are stopped 260 so as to thereby select the symbols to be displayed on the reels in the display area, as shown in FIG. 8. In the example shown in FIG. 8, the first, second and third reels 280, 282, 284 are stopped and the fourth and fifth reels 286, 288 continue to spin. As shown in FIG. 9, the fourth and fifth reels 286, 288 are then concealed from view, in this example by covering each of the fourth and fifth reels 286, 288 with a virtual shutter 300 implemented using a display device or a mechanical shutter.

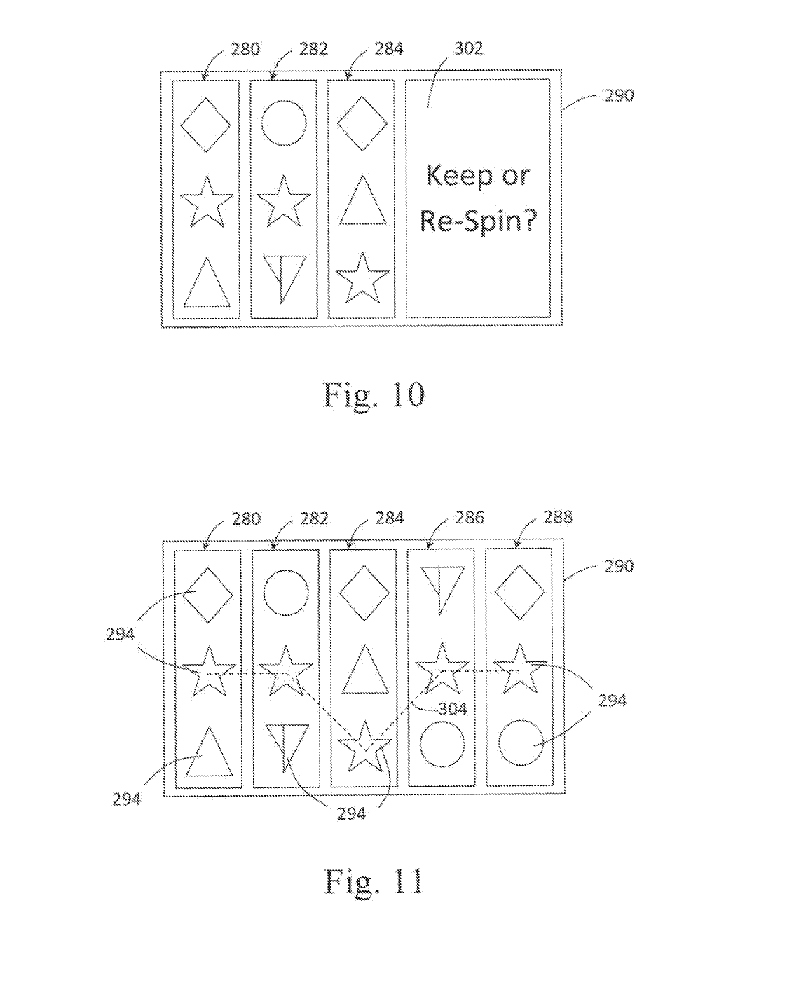

As indicated at step 262 of the flow diagram 250 and shown in FIG. 10, a request is made to the player to indicate whether the player wishes to keep the symbols displayed on the first, second and third reels 2280, 282, 284. In this example, this is achieved by displaying text 302 over the fourth and fifth reels, although it will be understood that other arrangements for communicating this request are envisaged.

If the player chooses to keep the symbols displayed on the first, second and third reels 280, 282, 284, symbols for display on the fourth and fifth reels 286, 288 are selected, the virtual shutters 302 open and the fourth and fifth reels 286, 288 are caused to stop 268 so as to display the selected symbols, as shown in FIG. 11. The displayed symbols 294 are then evaluated 272 by the outcome evaluator 28, and if the displayed symbols correspond to a win condition, a prize is awarded. In the present example, five STAR symbols corresponding to a winning combination are disposed along a defined win line 304 and a prize corresponding to this winning combination is awarded to the player.

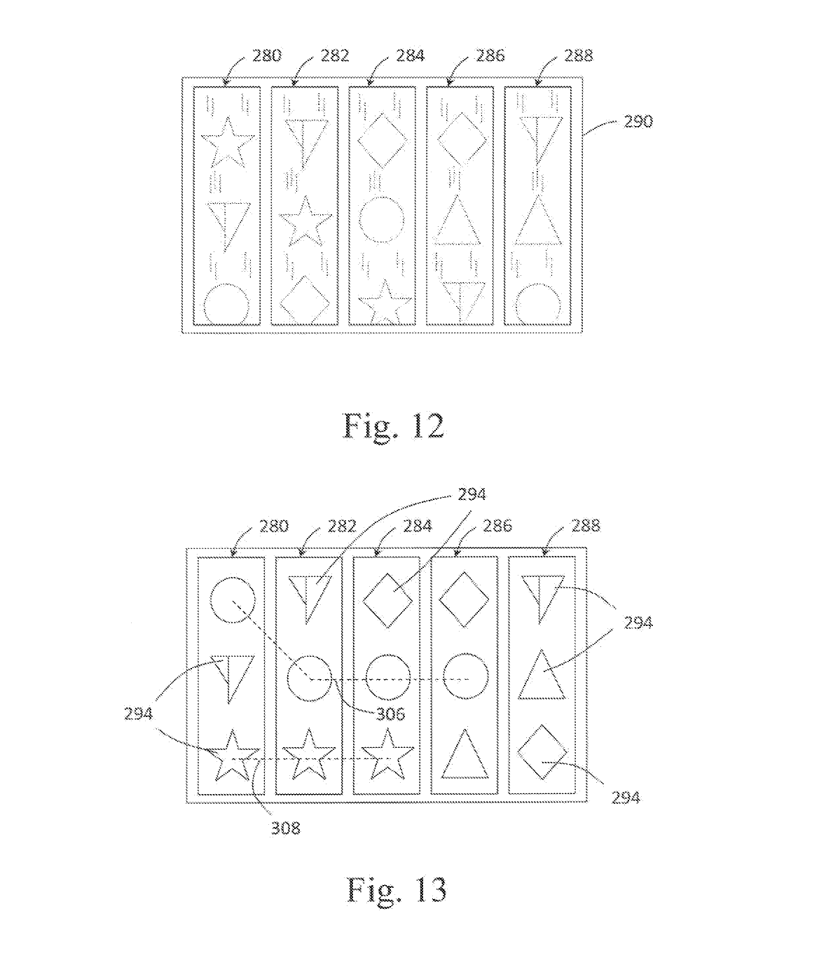

If the player does not choose to keep the symbols displayed on the first, second and third reels 280, 282, 284, symbols for display on all reels are re-selected, all five reels 280, 282, 284, 286, 288 are re-spun, as shown in FIG. 12, and all 5 reels subsequently caused to stop 270 so as to display the selected symbols, as shown in FIG. 13. The displayed symbols 294 are then evaluated 272 by the outcome evaluator 28, and if the displayed symbols correspond to a win condition, a prize is awarded. In the present example, four CIRCLE symbols corresponding to a winning combination are disposed along a first defined win line 306, and three STAR symbols corresponding to a winning combination are disposed along a second defined win line 308. Prizes corresponding to these winning combinations are awarded to the player.

It will be appreciated that in some embodiments the shutters may be omitted such that all reels are always visible during implementation of the feature game.

It will also be appreciated that the above feature game implementation described in relation to FIGS. 7 to 13 may be implemented in a base game of a multi-stage game or may be implemented in a gaming system arranged to implement a single stage game.

It will also be appreciated that instead of stopping the first three reels and providing a player with the option of keeping the symbols shown on the stopped reels, any one or more of the reels may be stopped and the player provided with this option, such as the first reel only, the first and third reels only, and so on. As a further variation, the stopped reels may be selected randomly.

While the above embodiment is described in relation to a gaming system wherein virtual reels are displayed on a graphical display device, it will be understood that, as an alternative, physical reels may be provided instead of virtual reels. With this embodiment, physical shutters may be provided to selectively conceal one or more of the reels.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

Modifications and variations as would be apparent to a skilled addressee are determined to be within the scope of the present invention.

1. A gaming machine for playing a wagering game, the gaming machine, comprising:
a housing;
a display supported by the housing, the display comprising a plurality of reels, each reel carrying a plurality of symbols;
a player interface supported by the housing, the player interface configured to receive input from a player of the gaming machine;
a credit mechanism configured to receive a bet from the player of the gaming machine and to award a prize to the player; and
a game controller configured to spin the plurality of reels, to stop a first subset of reels while permitting a second subset of reels to continue spinning such that the stopped, first subset of reels presents a first plurality of selected symbols via the display, and to request whether the player wishes to keep the first plurality of selected symbols displayed by the stopped, first subset of reels;
wherein, in response to receiving an instruction from the player via the player interface that indicates the player does not wish to keep the first plurality of selected symbols, the game controller is further configured to re-spin the stopped, first subset of reels, and to stop the plurality of reels to obtain a second plurality of selected symbols depicted by the stopped, first and second subset of reels;
wherein, in response to receiving an instruction from the player via the player interface that indicates the player wishes to keep the first plurality of selected symbols, the game controller is further configured to keep the first plurality of selected symbols and to stop the second subset of reels to obtain the second plurality of selected symbols depicted by the stopped, first and second subset of reels; and
wherein the game controller is further configured to determine whether the second plurality of selected symbols define a winning symbol combination for the wagering game, and to award a prize for the winning symbol combination via the credit mechanism.

2. The gaming machine of claim 1, further comprising at least one shutter arranged to conceal the second subset of reels until the instruction is received from a player indicative of whether the player wishes to keep the first plurality of selected symbols.

3. The gaming machine of claim 2, wherein the at least one shutter comprises a virtual shutter.

4. The gaming machine of claim 2, wherein the at least one shutter comprises a physical shutter.

5. The gaming machine of claim 2, wherein each reel of the second subset of reels has a separate associated shutter.

6. The gaming machine of claim 1, wherein each reel of the plurality of reels is a virtual reel.

7. The gaming machine of claim 1, wherein each reel of the plurality of reels is a physical reel.

8. The gaming machine of claim 1, wherein the first subset of reels comprises three adjacently disposed reels of the plurality of reels.

9. The gaming machine of claim 8, wherein the three adjacently disposed reels are leftmost disposed reels of the plurality of reels.

10. The gaming machine of claim 1, wherein the first subset of reels comprises at least one reel randomly selected from the plurality of reels.

11. The game machine of claim 1, wherein:
the wagering game is a feature game; and
the game controller is further configured to commence the feature game when a trigger condition occurs in a base game.

12. The game machine of claim 1, wherein:
the wagering game corresponds to a special game mode; and
the game controller is further configured to commence the special game mode in response to player input, based on an amount or type of bet placed, or when a special game is purchased by the player.

13. A method of playing a wagering game of a gaming machine having a plurality of reels that each comprise a plurality of symbols, the method comprising:
receiving a bet from a player of the gaming machine via a credit mechanism of the gaming machine;
spinning the plurality of reels of the gaming machine;
stopping a first subset of the reels while permitting a second subset of reels to continue spinning such that the stopped, first subset of reels present a first plurality of selected symbols via a display of the gaming machine;
receiving an instruction from the player indicative of whether the player wishes to keep the first plurality of selected symbols;
if the instruction from the player indicates that the player does not wish to keep the first plurality of selected symbols, re-spinning the first subset of reels and stopping the plurality of reels to obtain a second plurality of selected symbols depicted by the stopped, first and second subset of reels;
if the instruction from the player indicates that the player wishes to keep the first plurality of selected symbols, keeping the first plurality of selected symbols and stopping the second subset of reels to obtain the second plurality of selected symbols depicted by the stopped, first and second subset of reels;
determining whether the second plurality of selected symbols define a winning symbol combination for the wagering game; and
paying out a prize for the winning symbol combination via the credit mechanism of the gaming machine.

14. The method of claim 13, further comprising concealing the second subset of reels until the instruction is received from the player indicative of whether the player wishes to keep the first plurality of selected symbols.

15. The method of claim 13, wherein stopping the first subset of reels comprises stopping three adjacently disposed reels of the plurality of reels.

16. The method of claim 13, wherein stopping the first subset of reels comprises stopping three, leftmost adjacently disposed reels of the plurality of reels.

17. The method of claim 13, further comprising randomly selecting at least one reel from the plurality of reels for the first subset of reels.

18. A tangible computer readable medium, comprising computer readable program code that in response to being executed, causes a gaming machine to:
accept a bet from a player of the gaming machine via a credit mechanism of the gaming machine;
spin a plurality of reels of the gaming machine;
stop a first subset of the reels while permitting a second subset of reels to continue spinning such that the stopped, first subset of reels present a first plurality of selected symbols via a display of the gaming machine;
in response to an instruction received from the player indicating that the player does not wish to keep the first plurality of selected symbols, re-spin the first subset of reels and stop the plurality of reels to obtain a second plurality of selected symbols depicted by the stopped, first and second subset of reels;
in response to an instruction received from the player indicating that the player wishes to keep the first plurality of selected symbols, keep the first plurality of selected symbols and stop the second subset of reels to obtain the second plurality of selected symbols depicted by the stopped, first and second subset of reels;
determine whether the second plurality of selected symbols define a winning symbol combination for the wagering game; and
cause the credit mechanism of the gaming machine to pay out a prize for the winning symbol combination.

19. The tangible computer readable medium of claim 18, wherein the computer readable program code, in response to being executed, further causes the gaming machine to stop the first subset of reels by stopping three, leftmost adjacently disposed reels of the plurality of reels.

20. The tangible computer readable medium of claim 18, wherein the computer readable program code, in response to being executed, further causes the gaming machine to randomly select at least one reel from the plurality of reels for the first subset of reels.
